(19) United States
(12) Patent Application Publication
(10) Pub. No.: US 2002/0028655 A1
(43) Pub. Date: Mar. 7, 2002

(54) Repeater system

(76) Inventors: Douglas K. Rosener, Santa Cruz, CA (US); Bruce F. Bishop, Aptos, CA (US); Timothy Milam, Soquel, CA (US); Emmett J. Powers, San Diego, CA (US)

Correspondence Address: PERKINS COIE LLP, PATENT-SEA, P.O. BOX 1247, SEATTLE, WA, 98111-1247, US

(21) Appl. No.: 09/746,356

(22) Filed: Dec. 22, 2000

Related U.S. Application Data
(63) Continuation of application No. 09/616,386, filed on Jul. 14, 2000.

(51) Int. Cl. H04B 7/14

(52) U.S. Cl. 455/16; 455/13.1

(57) ABSTRACT

A repeater system for wireless communications applications is, in one aspect, programmable and controllable in a manner that enables multi-user, multiband, and multi-protocol operation. The repeater system includes a repeater coupled to an inside antenna system and to an outside antenna system, either or both of which may be adaptive. Inside cellular phones are coupled via links (that may be cellular or non-cellular) to the repeater and to a control unit, which is itself connected by a link to the repeater. The repeater includes a repeater core coupled to a control component. The core is constructed from a number of modules, the selection of which determines the operation and functionality of the repeater core. Core modules, selectively enabled by a user, establish one or more of the following modes of operation: passive, single-frequency active (SFA), Up/Down Converter (UDC), Remote Wireless Modem (RWM), and Shared-Identity repeater operation.

### CROSS-REFERENCE TO RELATED APPLICATION

This application is a continuation of U.S. patent application Ser. No. 09/616,386, filed Jul. 14, 2000, currently pending.

### BACKGROUND OF THE INVENTION

1. Field of the Invention

The invention relates to repeater systems and, more particularly, to repeater systems for wireless communications, wherein repeater operating characteristics are selectable, thereby rendering the repeaters adaptive, so as to enable numerous forms of multi-band, multi-user, and multi-protocol capability.

2. Description of the Related Art

Wireless telephones, including cellular telephones, have become nearly ubiquitous devices that are used not only for the purpose of voice communications, but also as a gateway to myriad sources of data and information, including the Internet. Currently, the proliferation of wireless communications devices, such as cellular telephones, has accelerated to the point that cellular telephones are predicted by some to ultimately displace wired communications facilities. In addition, cellular telephone sales now exceed sales of personal computers (PCs) by a margin of approximately two to one, and it is anticipated that this margin will expand. As cellular telephone technology has evolved, cellular telephone functionality has become correspondingly more robust, and cellular phones now offer capabilities that were once the exclusive province of PCs. In fact, some cellular telephones resemble small, low-end PCs with wireless access to data networks, including the Internet. Surprisingly, it is now believed that many consumers acquire cellular telephones merely as an Internet-access appliance.

As consumer involvement in wireless communication capabilities rapidly evolves beyond simple mobile voice communication, the maintenance of a high-quality and reliable link between a cellular telephone and surrounding communications and information networks becomes increasingly important. However, the reliability of the cellular communications link is severely called into question on occasions when the user attempts to engage in cellular communications while occupying a vessel, such as an automobile, train, aircraft, subway, bus, or other vehicle, or a fixed structure, such as a building or other edifice.

In these instances, structures, in the form of wood, plaster, metals and plastics associated with the vessel or edifice may be either conductive or absorptive of electromagnetic energy and may therefore interpose substantial attenuation of the RF signal that is transmitted or received by the cellular telephone. The attenuation is experienced as signal-path loss between the telephone and a base station, and is often manifested as a deterioration in received or transmitted signal quality or as an interruption in communications. The effects are even more severe if the telephone is stored in a briefcase, pocket, or glove box. In addition to interposing signal-path loss, the interior of a vessel or edifice provides a complex environment for the operation of antenna systems, resulting in appreciable signal reflection and anomalous polarization shifts.

U.S. Pat. No. 5,600,333 describes an active repeater assembly for in-vehicle use of personal communication devices. The repeater assembly includes an RF amplifier coupled to first and second antennas and is characterized by the absence of removable coaxial connectors between the antennas and the amplifier. The outside antenna is an on-glass device, mounted on the exterior surface of the window. In one embodiment, instability may be prevented by the provision of isolation, in the form of electromagnetic shielding, between the inside and outside antennas. Other types of antenna isolation are known in the art and are suggested below.

Vehicle antenna systems are also described in U.S. Pat. No. 5,155,494 and Re. 36,076. See also U.S. Pat. Nos. 5,697,052; 5,802,452; 5,832,365; 6,049,315; and 5,059,971.

### SUMMARY

In one aspect, a wireless communications device, such as a cellular phone or a personal digital assistant, having a wireless interface is located relative to a structure, for example, a vessel or edifice, so that the structure affects in some manner a wireless link normally formed by the wireless interface across the structure. The effects of the structure are mitigated by use of a repeater. In one embodiment, the repeater is coupled to two antenna systems: a first antenna system located inside the structure used to form the wireless link, and a second antenna system located outside the structure. Depending on the embodiment, either or both antenna systems are adaptive or “smart” antenna systems.

One implementation of the repeater includes control circuitry, in the form of, for example, a repeater control unit that controls operation of one or more portions of the repeater. The repeater control unit is coupled to a repeater core. The repeater core is a part of the repeater system that does not include the antennas and owner control circuitry. In some embodiments, the repeater control circuitry changes the repeater's operation in response to instructions received via a wireless link. Depending on the embodiment, the above-described wireless device, or an owner control unit, may provide such instructions to the repeater control circuitry. In one such embodiment, a wireless device includes logic that decides when to turn the repeater ON and OFF in accordance with a technique called “smart handover”. In another example, the just-described control circuitry includes logic to discriminate between users and/or phone types and to select users and phone types that are granted access in accordance with a technique called “qualified handover”.

In another aspect, the repeater core may include core modules that are selectable to establish one or more operating characteristics and/or the functionality of the repeater. In one embodiment, a number of core modules are physically installed within the repeater core, but a number of the modules may normally be maintained inoperable. One or more core modules to be used with a wireless device are selectively enabled as and when necessary. In another embodiment, one or more core modules are physically stored outside the repeater and are inserted into the repeater when necessary. Depending on the embodiment, the repeater control unit may or may not be physically incorporated into the repeater.

The core modules that may be selected include, but are not necessarily limited to: (i) a first module (hereinafter “Passive module”) that consists essentially of a passive network, that is, a network requiring no external application of energy for operation, disposed between the inside and outside antenna systems; (ii) a second module (hereinafter “Same Frequency Active (SFA) module”) that includes two amplifiers: a first amplifier having an input line for coupling to the inside antenna system and having an output line for coupling to the outside antenna system, a second amplifier having an input line for coupling to the outside antenna system and having an output line for coupling to the inside antenna system; and (iii) a third module (hereinafter “Up/Down Converter (UDC) module”) that contains at least two channels: an inside-to-outside channel and an outside-to-inside channel.

In one embodiment, the UDC module changes the frequency of a signal received at the input line of each channel so that a signal of different frequency is provided at the output line. For example, a 100 MHz applied signal at the input may be changed to 800 MHz at the output, and vice versa. In one implementation, the gain control is changed simultaneously for both forward (base-station-to-phone) and reverse (phone-to-base-station) communication.

In another embodiment, a repeater system includes a module consisting of an RF transceiver and a baseband interface. The user phone directs baseband information to the module, which processes the received information to modulate an RF carrier and then radiates the carrier. In the forward direction, the module demodulates a received RF carrier, and processes and directs baseband information to user's phone.

In yet another embodiment, a repeater system includes a repeater core operative to effect a link with a cellular telephone, the repeater core including a Shared Identity module that enables the repeater to assume, and operate with, the identity of an associated cellular telephone. The Shared Identity module includes a telephone core, a shared-identity program storage device and a high-level data interface. The shared-identity program storage device stores identity information and operating information that is transferred from a cellular telephone. An outside adaptive antenna system is coupled to the repeater core.

In another aspect, a method of operating a cellular telephone inside a vessel or a building includes coupling the cellular telephone to an adaptive repeater that in turn includes a Shared Identity module. Identity information and operating information are transferred from the cellular telephone to the Shared Identity module. In the Shared Identity module, a shared identity program is operated so as to impart identity information and operating information to the telephone core.

Some embodiments of the invention incorporate a repeater control unit that includes a processor, a memory, a communications interface between the processor and a communications link, an antenna interface for coupling the processor to an antenna system, and a repeater core interface for coupling the processor to a repeater core module.

In a further aspect, a repeater has multiple (for example, four) antennas that enable multiband and/or multiprotocol operation. In one example, the repeater has a Passive core module and has two antennas: one antenna compatible with the Untied States PCS frequency band (1850-1990 MHz) and JSTD008 CDMA and another compatible with the United State cellular frequency band (824-894 MHz) and 15-136 TDMA (AMPS). Accordingly, both protocols, and both bands, may be accommodated by the repeater.

### BRIEF DESCRIPTION OF THE DRAWINGS

The subject invention may be better understood, and its numerous objects, features, and advantages made clear to those skilled in the art be referring to the accompanying Drawings, in which:

FIG. 1 is a high-level block diagram of one embodiment, depicting a repeater coupled to both an inside and an outside antenna system, an owner control unit linked to the repeater, and a number of inside wireless devices, such as, for example, cellular telephones, also linked to an owner control unit and to the repeater.

FIG. 2 is a block diagram depicting the repeater architecture, including a repeater core and a repeater control unit.

FIG. 3 is a graphical representation of the repeater core architecture, indicating the manner in which the core is constructed from a number of core modules that are controlled by the repeater control unit.

FIG. 4 is a graphical representation of an adaptive antenna system architecture in which multiple antennas are coupled through a gain/phase multiplex array, the array controlled by a gain/phase controller, to a plurality of core ports.

FIG. 5 is a block diagram of a repeater control unit including a processor, memory, and interfaces to the repeater core, to inside and outside adaptive antenna systems, and to a communications link.

FIG. 6 is a graphical representation of a Passive core module.

FIGS. 7A and 7B are block diagrams of two embodiments of Same Frequency Active (SFA) broadband core module, including gain-controllable amplifiers and, in one embodiment, inside and outside duplexers.

FIG. 8 is a block diagram of an Up/Down Converter (UDC) core module that includes band-limited amplifiers with gain/bandwidth control, a frequency synthesizer, and a mixer array coupled to synthesizer outputs.

FIG. 9A is a generalized depiction of a Remote Wireless Modem (RWM core module.

FIG. 9B is a detailed block diagram of an exemplary, commercially available remote wireless modem that can be used as described herein.

FIG. 10 is a graphical depiction of a Shared Identity core module, indicating components that assist in the personalization of a repeater so as to emulate a user phone through the operation of a shared identity software module and a high-level data interface that is coupled to the repeater control unit.

FIG. 11 is a graphical representation of modifications imported to a conventional cellular telephone so that the telephone becomes interoperable in one embodiment.

FIG. 12 is a graphical representation of an owner control unit, including user interface hardware and software and a link control unit.

FIG. 13 is a block diagram of a SFA module including a circulator used as a duplexer for antenna isolation to promote system stability and/or performance.

The use of the same reference symbols in different drawings indicates identical items unless otherwise noted.

### DETAILED DESCRIPTION

For a thorough understanding of the subject Adaptive Repeater System, reference is made to the following Detailed Descriptions, including the appended Claims, in connection with the above-described Drawings.

In one embodiment, an antenna system of a repeater is placed inside a human inhabitable structure such as a vessel or edifice. The repeater intercepts, and amplifies, a signal normally transmitted or received by a wireless device operated within the vessel or edifice. In one implementation, the repeater is coupled to two antenna systems: an inside (the vessel or edifice) antenna system (also called “internal antenna system”), and an outside antenna system (also called “external antenna system”). As is well known to those skilled in the art, numerous embellishments and elaborations may be made to such a repeater system.

In one repeater system in accordance with the invention, the repeater is compliant with an array of protocols and operates on disparate frequency bands. Consequently, the repeater is able to accommodate a wide variety of wireless telephone technologies with little, if any, modification to the repeater hardware or software. For example, the repeater hardware and/or software is modularized. Hardware and/or software modules are selected to allow the repeater to assume different operational personalities, depending on the particular modules installed. Such a repeater may anticipate and be amenable to forthcoming protocols and frequency-band allocations. Introduction of yet-to-be implemented communication techniques do not require the automobile/repeater owner to consider his repeater system obsolete.

In one embodiment, such a repeater is accessed by multiple users. For example, both the passenger and the driver of a vehicle avail their cellular telephones by use of the repeater. An office building may house many cellular telephone users, each of whom may, at any time, engage in voice communications or data exchange. Conversely, it may be expected that the manufacturer of an automobile, or the owner of an office or apartment building, may perceive advantage, as by virtue of business arrangements with suppliers or manufacturers of wireless telephones, in limiting the repeater's use to a specific telephone brand or protocol. Accordingly, cellular telephone usage in a building may be confined to a specified, or a limited number of, users. In general, the repeater owner may seek to control access to such an adaptive repeater.

Some repeater embodiments in accordance with the invention may be generically classified in accordance with Table 1 below. In one implementation, specific repeater embodiments are realized through the selection of repeater core modules in a manner explained below. Accordingly, the repeater systems described herein are deemed adaptive because specific operational personalities may be imparted to the repeater through the selection and installation of various modules, as described below.

TABLE 1
Repeater Embodiments

| REPEATER | | |
|---|---|---|
| TYPE | RECEIVE MODE | TRANSMIT MODE |
| Passive | One or more external antennas | One or more internal an- |
| | receive RF signal from a base | tennas receive RF signal |
| | station and re-radiate on one | from the phone and re- |
| | or more internal antennas, | radiate on one or more ex- |
| | without amplification | ternal antennas without |
| | | amplification |
| Same | One or more external antennas | One or more internal an- |
| Frequency | receive RF from base station, | tennas receive RF signal |
| Active | amplify it and re-radiate it on | from the phone, amplify it |
| (SFA) | one or more internal antennas | and re-radiates it on one or |
| | to the phone, with no change | more external antennas, |
| | in frequency. | with no change in fre- |
| | | quency. |
| Up/Down | One or more external antennas | One or more internal an- |
| Converter | receive RF from base station, | tennas receive RF from |
| (UDC) | convert it to another fre- | phone, convert it to another |
| | quency and re-radiate on one | frequency and re-radiate on |
| | or more internal antennas to | one or more external |
| | phone. | antennas. |
| Remote | One or more external antennas | Baseband data is sent using |
| Wireless | receive RF from base station | data link from phone to |
| Modem | at a specified protocol, apply | modem, modem converts |
| (RWM) | it to modem to convert it to | data to cellular RF using |
| | baseband data and send the | the specified protocol and |
| | data using data link to phone. | radiates on one or more ex- |
| | Modem control issues are | ternal antennas to base sta- |
| | managed remotely by user | tion. Modem control issues |
| | phone. | are managed remotely by |
| | | user phone. |
| Shared | One or more external antennas | Baseband data is sent using |
| Identity | receive RF from base station, | data link from phone to |
| phone | apply it to an embedded | embedded phone, pro- |
| (Clone) | phone programmed with the | grammed with the same |
| | same identity as the user | identity as the user phone. |
| | phone. Received data is sent | Phone radiates on one or |
| | using data link to user phone. | more external antennas to |
| | | base station. |

One embodiment includes a repeater system that is multiband, multi-user, and multi-protocol, and that is controlled using a wired or wireless connection. Note however, that in other embodiments, the system may have any one or more of the three features: multiband, multi-user and multi-protocol. Depending on the implementation, such a system may include any one or more of the repeater embodiments identified in Table 1.

Multiband operation may be achieved by using multiple band-limited antennas and/or one, or a limited number of, wideband antennas. Multiband repeater operation also requires either that the repeater core be inherently wideband or, in an alternative embodiment, that multiple repeater core modules be deployed. Multi-user, multi-protocol operation is realized in some embodiments by designing the repeater to be inherently wideband. That is, the receiver is designed to present a bandwidth that accommodates, for example, both the PCS and US cellular frequency bands of operation. In other embodiments, multi-user, multi-protocol operation is achieved by constructing the repeater from multiple modules, each of which modules accommodates one or more protocols. In one embodiment, the repeater adapts to the electromagnetic environment, both inside and outside the vessel or edifice, by using an adaptive antenna system.

Programming and control of the repeater is effected via a link to the repeater. The link may be a wired link or a wireless link. A wireless link may include, for example, an optical link or an RF link or a combination of the two. The link may, or may not, employ standard cellular network frequencies, depending on the embodiment. Programming establishes the parameters of repeater operation and stores security codes. Control is used to enable and disable the repeater, or to communicate the cellular link information necessary for repeater operation.

In addition, a cellular phone used with the system can be provided the capability of deciding when to turn the repeater ON and OFF. This technique shall be hereinafter referred to as “smart handover”. The repeater itself has the ability to discriminate between users and/or phone types and to determine the users and phone types that will be granted access. This is called “qualified handover”.

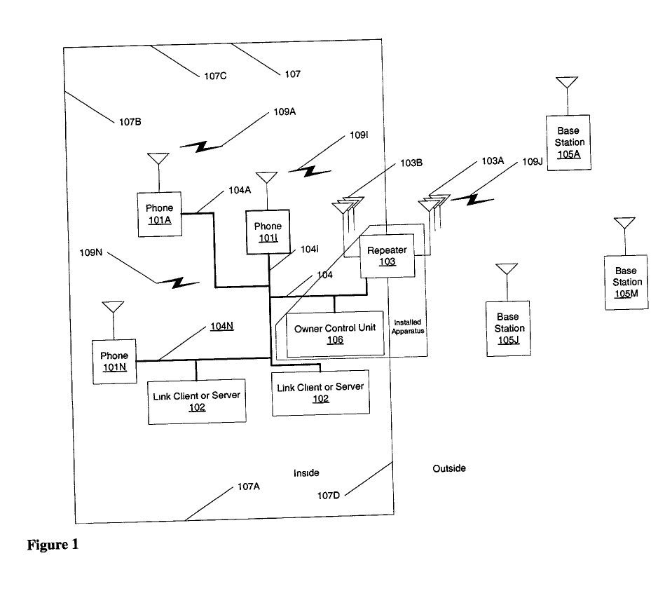

An adaptive repeater system of one embodiment resides anywhere relative to a structure 107 in which a cellular phone or other wireless device is located. That is, the repeater system may reside completely inside such a structure, or completely outside, or in-between, as shown in FIG. 1. In some embodiments, an antenna system 103B is located in structure 107, while a portion of the repeater system is located outside. In other embodiments (not shown) the entirety of the repeater system is located outside (or inside) structure 107. Structure 107 may be an edifice (e.g., building) or a vessel. Note that structure 107 need not be an enclosure. For example, portions 107A-107C may be omitted. Portion 107D may contribute to the distortion of any direct wireless signal between a phone 101I and a base station 105J.

A repeater system of one embodiment enables reliable communication between one or more wireless devices 101A-101N (wherein A≦I≦N, N being the total number of such devices), disposed within structure 107, and base stations 105A-105M (wherein A≦J≦M) that are located outside of structure 107. In one embodiment, devices 101A-101N are cellular phones, such as the model T28, available from Ericsson. The T28 is a dual-band GSM telephone that includes a Bluetooth interface, including circuitry and embedded antenna, WAP programming, and software added to use services provided by a repeater of the type described herein, such as the Shared Identity service.

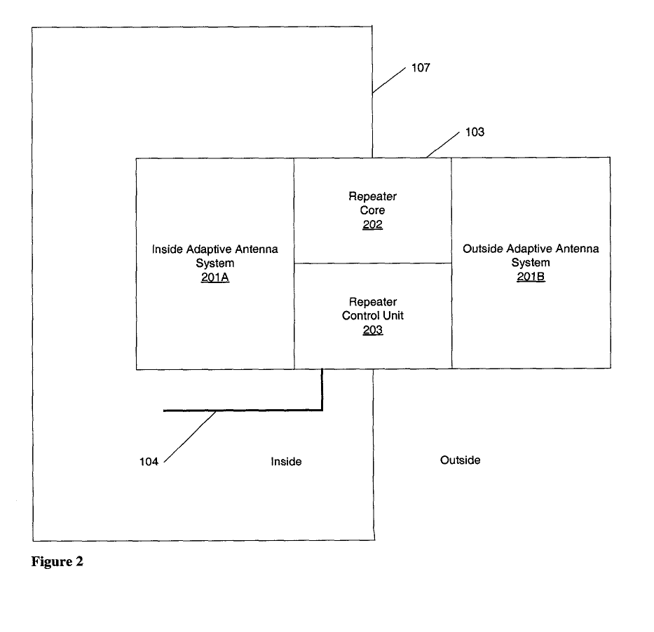

The repeater system includes a repeater 103 and an owner control unit 106. Owner control unit 106 may be provisioned in one of many alternative embodiments. That is owner, control unit 106 may, as depicted in FIG. 1, be coupled to repeater 103 on a communications link 104. Link 104 may also be accessed by other system components. Specifically, wireless device 101, control unit 106, and repeater 103 communicate over a link 104 that may, in an embodiment, be Bluetooth compatible. For a discussion of Bluetooth, see Jennifer Bray and Charles Sturman, Bluetooth: Connect Without Cables, Prentice Hall (2000). In the alternative, owner control unit 106 may be hard wired to repeater 103 through appropriate cabling, or may be incorporated into the same mechanical assembly as is repeater 103. In any case, it is important to maintain a distinction between owner control unit 106 and the repeater control unit, as identified by reference numeral 203 in FIGS. 2 and 5.

One embodiment includes client or server devices or applications 102 that have access to link 104. Examples of such devices or applications include laptop computers or automobile locking systems. It is worthy of note that link 104 in one embodiment is highly dynamic, as various devices may autonomously establish and tear down connections, via link 104, among themselves, repeater 103, and the owner control unit 106.

A function of owner control unit 106 is to control and program the operation of repeater 103. One embodiment accommodates multiple deployments of separate owner control units 106, such as in the dashboard of the automobile or embedded in the cellular phone. The repeater 103 is coupled to an inside antenna system 201a and to an outside antenna system 201b. In addition, each wireless device 101I is equipped with one or more antennas. In one multi-antenna example of repeater 103, one antenna each is used for each cellular band, and one antenna is used for Bluetooth communications. In another example, a single multiband antenna is employed to cover two or more bands. When active (enabled), repeater 103 intercepts cellular traffic from a device 101I via inside antenna system 201a and repeats that traffic via outside antenna system 201b to a base station 105J. Conversely, repeater 103 intercepts base station traffic and repeats it to wireless device 101I through the inside antenna system 201a.

One embodiment of repeater 103 includes an inside adaptive antenna system 201a, an outside adaptive antenna system 201b, a repeater control unit 203, and a repeater core 202. The need for inside adaptive antenna system 201a is obviated in repeater system configurations that incorporate a RWM repeater core or a Shared Identity repeater core. In one such configuration, a baseband signal from a cellular telephone 101I is sent over link 104 to repeater control unit 203, and the cellular telephone's RF section is disabled. Adaptive antenna systems 201a and 201b, discussed in detail infra, are controlled in a manner intended to optimize reception or transmission of the signal to and from repeater core 202.

Repeater control unit 203 communicates via link 104 with owner control unit 106 and with wireless device 101I (FIG. 1). During operation, repeater control unit 203 exchanges information with adaptive antenna systems 201a and 201b, and/or with repeater core 203. Repeater core 203 receives one or more RF signals from a signal source, which may be, for example, adaptive antenna system 201a and/or 201b or repeater control unit 203. The repeater retransmits the received signals to a signal sink, for example, adaptive antenna systems 201a and/or 201b, or repeater control unit 203.

Adaptive antenna systems, also known as “smart” antenna systems, are familiar to those skilled in the art and are thoroughly treated in the technical literature. See, for example, Joseph C. Liberti, Jr. and Theodore S. Rappaport, Smart Antennas For Wireless Communications, Prentice Hall (1999). Many known adaptive antenna systems may be suitable for use as a component of an adaptive repeater system as described herein.

Systems 201a and 201b, when implemented by adaptive antenna systems, are capable of processing one or more characteristics of one or more intercepted RF signals and dynamically adjusting the gain and phase of a gain/phase array to optimize the signal presented at the output of the associated antenna ports. The output at each antenna port is a combination of the core inputs. The effective linear combination coefficients determined by the characteristics of the gain/phase array. One embodiment of an adaptive antenna system analyzes the signals at respective antenna ports and computes proper combination coefficients applicable to individual antennas in the array so as to achieve predetermined reception criteria. Another embodiment uses beam switching, as discussed below. In one embodiment, an adaptive antenna system optimizes the antenna pattern based on a signal received by a component of the system, such as the phone or the receiver. For example, a wireless device 101I (FIG. 1) can instruct the repeater 103 to continue to adjust the pattern to improve the reception of wireless devices 101I.

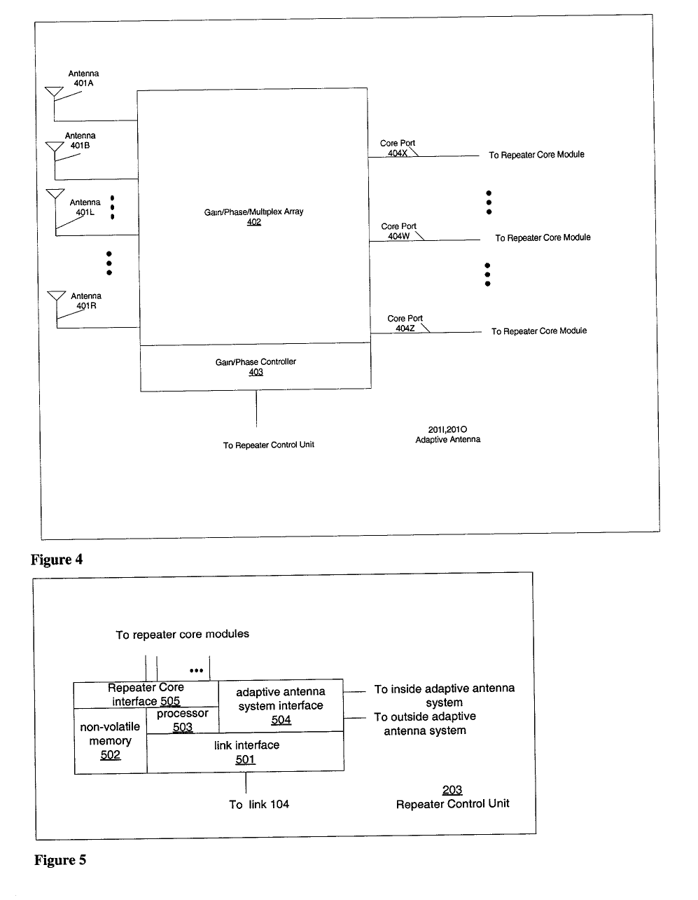

One adaptive antenna system in accordance with the invention is depicted in FIG. 4. Specifically, gain/phase controller 403 samples an RF signal on a port 404 and monitors the strength of that signal. The repeater system, through the operation of repeater control unit 203, processes the monitored data and, through gain-phase controller 403, continually adapts the gain/phase multiplex array 402 in order to enhance, as by optimizing the signal strength, the signal on the associated port 404. Each signal appearing at a core port 404 of gain/phase multiplex array 402 is a linear combination of the signals at antenna ports 401L. The linear combination coefficients determine the gain and phase shift applied to each input and is established by gain/phase controller 403. Repeater controller unit 203 communicates with gain/phase controller 403 to perform specified tasks, such as selectively disabling one or more output ports 404.

Note that any antenna port of antennas 401A-401 N (wherein A≦L≦R, R being the total number of such antennas) can be connected to any one or more of core ports 404X-404Z (wherein X≦W≦Z, Z being the total number of such core ports), and array 402 provides an appropriate gain and phase for each link therebetween.

Beam switching represents a specific application of adaptive antenna control that generally requires less processing than a continually controlled adaptive system. Beam switching simply contemplates a limited, discrete set of gain and phase combinations in order to achieve the requisite antenna array adaptation. A particularly simple example of the beam switching approach to adaptive antenna control is confined to the switching of particular antennas in an array ON and OFF in various combinations.

In one embodiment, multiple antenna connections in the adaptive antenna system are combined passively, that is, with fixed gain and phase characteristics and without antenna switching. In such an embodiment, at least one of the antennas in the array receives the desired signal. This technique effectively increases the antenna capture area, relying on the spatial diversity of individual antennas in the array to automatically adapt to the locale of the mobile telephone. In the limit, a single antenna represents a special, and the simplest, embodiment of an adaptive antenna system, in which the array consists of a single antenna and its gain and phase are fixed. The subject adaptive repeater system, in some embodiments, deploys adaptive antenna systems for both inside and outside antenna coverage.

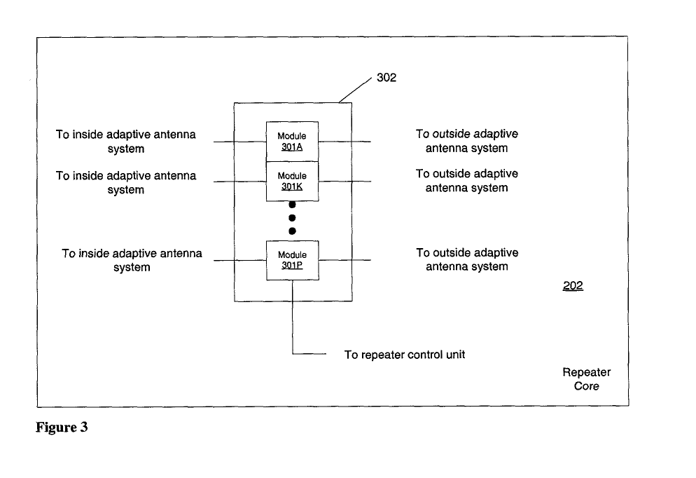

Referring now to FIG. 3, the repeater core in one embodiment may be constituted from one or more core modules 301A-301P (wherein A≦K≦P, P being the total number of such modules). In a manner explained elsewhere herein, core modules 301A-301P provide different characteristics, functionalities, and capabilities and, in this manner, determine the characteristics, functionalities, and capabilities of the repeater 103 (FIG. 1) that they constitute. The core modules thereby defining the repeater type in accordance, for example, with the categories of Table 1 above. Specific core module types are described elsewhere.

Circuitry in particular core modules depends on communication or control with repeater control unit 203. For example, an SFA (Single Frequency Active) module may require gain control from the repeater control unit 203. As another example, a Shared Identity module requires that cellular traffic encoded by a cellular modem from the wireless device be directed to the core module. The cellular traffic is conveyed in a high-level format, not encoded by a cellular modem.

In one implementation, two (or more) T28 GSM phones of the type described in reference to wireless device 101I are used as core modules of the repeater core. Such phones are enclosed in a plastic radome and mounted in the roof of a car on a plastic plate that replaces any metal sheeting in the roof. In this embodiment, the Bluetooth interface communicates with wireless devices inside the car, and RF interface communicates with a base station outside the car. In this implementation, the T28 phones already include the repeater control unit as well as the outside adaptive antenna system. T28 phones are programmed with customized software to provide various services to wireless devices 101A-101N. Specifically, the T28 phones may be programmed to assume the identity of a wireless device 101I. In this application, the T28 phone in the repeater over-writes its own identity information with identity information received from wireless device 101I.

In one embodiment, modules 301A-301B are designed to be configurable by the manufacturer or the user. For example, an automobile repeater manufacturer might desire that a user's ability to enable a module depend on the type of telephone the user possesses. As an additional example, the repeater owner may provision the repeater system with additional core modules 301 in order to afford other occupants access to the repeater system. This approach is enabled by the availability of multiple connectors into which particular modules 301 may be selectively inserted. Furthermore, module-operating protocols are in some embodiments rendered programmable through software resident in repeater control unit 203.

An embodiment of a repeater control unit 203 to be incorporated as a component of a repeater system is depicted in FIG. 5. As seen therein, repeater control unit 203 includes a processor 503 and a memory 502 coupled to the processor. Memory 502 may, for example, be a non-volatile memory that retains programming in the absence of applied power, or may be volatile memory that requires reprogramming or refreshing. Processor 502 may have a limited amount of on-chip memory, and this memory may need to be supplemented by additional external memory. For the following discussion, memory 502 represents all memory capacity available to processor 503 in a particular repeater control unit.

Processor 502 participates in communications over link 104 through link interface 501. Interface 501 in some embodiments includes hardware line drivers and line receivers that are necessary to interface to link 104. The protocol observed in communication over link 104 is established by processor programming as described elsewhere herein.

Repeater processor 503 additionally controls the repeater core modules 301 through repeater core interface 505. Control of the core may be effected by the simple selective enabling/disabling of core modules, or may be effected by appreciably more sophisticated operations. When used in connection with certain types of core modules, SFA, UDC, and RWM, for example, processor 503 may apply gain control to amplifier stages in those modules. In some instances, repeater core interface 505 is the instrument by which control signals and data are conveyed to a RWM module. Accordingly, repeater core interface 505 is specific to core modules with which it is called upon to interoperate. For example, SFA core modules may require that interface 505 contain a D/A converter to apply an analog gain control signal to SFA module amplifier stages.

Processor 503 optionally communicates with adaptive antenna systems 201a and 201b through an adaptive antenna interface 504. Interface 504 may be used to deliver signals corresponding to parameters that control signal optimization, or may deliver signals that selectively enable/disable the adaptive antenna systems. Memory 502 stores processor program instructions, as well as data representing, for example, acceptable user telephone property values and security passwords.

In some embodiments of the invention, repeater control unit 203 may be combined with the adaptive antenna system gain/phase controllers 403. In other embodiments, repeater control unit 203 may be integrated with the repeater core modules 301.

Link 104 is used to control repeater operation, and is distinct from the wireless link 1091 normally used by device 101I to communicate with base station 105J e.g. when both are located outside of structure 107. Note that in one embodiment, a number of different wireless links 109A-109N, which may operate on different frequency bands and/or comply with different protocols, are used by the respective devices 101A-101N simultaneously. Repeater 103 contains appropriate core modules to facilitate communications with the respective base stations.

In conjunction with RWM or Shared Identity repeaters, link 104 transfers cellular data and connects the repeater to one or more cellular telephones and to the owner control unit 106. Although in some embodiments, a wireless device may itself comprise an owner control unit. Also, a wireless device 101I may have its wireless interface disabled, and all communications occur over link 104. Link 104 may be wired, wireless, or a combination thereof Alternatively, link 104 may be formed by use of the wireless interface, in which case links 104 and 109 are identical. In still another embodiment, both links 104 and 109 are present and are used as described herein for control and data, respectively.

It is contemplated that any existing or prospective cellular or non-cellular data link design shall be appropriate for use as link 104. Link 104 may be a wired interface such as USB or RS-232, or may be a wireless interface, such as wireless LAN 802.11, the IrDA serial interface, Bluetooth or HomeRF.

Repeater 103 may be mounted inside an automobile, and be controlled through the DC wire harness of the automobile. Control may be implemented either through the wire harness alone or the wire harness in combination with a wireless link, or a wireless link alone.

Link 104 enables numerous forms of necessary communications, depending on the embodiment, such as:

Repeater Programming. Repeater 103 must be programmed to establish the criteria for qualified handover (defined elsewhere herein) and must contain security that qualifies entities authorized to program the repeater.

Power Control. In some embodiments the gain of repeater 103 is controlled over link 104, for example, by phone 101I or by owner control unit 106.

Telephone Properties. The repeater is afforded the capability of querying wireless telephones 101, over link 104, for user identification, protocol, frequency of operation, and other properties. The telephone properties of a phone 101I are queried over link 104, and are used by repeater 103 to decide whether access is granted in a qualified handover scheme.

Repeater Switch Request. In “smart handover” operation, the repeater receives autonomous commands from the telephone over link 104 to turn ON or OFF. Alternatively, a direct request from a user may be delivered over link 104 from the telephone or owner interfaces.

Cellular Data. In RWM or Shared Identity repeaters, cellular data is transmitted over link 104. In this mode of operation, repeater 103 translates data, via modems, between the cellular link and link 104.

In order to be compatible with a repeater system, modifications may be required to the user's cellular telephone. Specifically, the user's cellular telephone may require modification when used with a UDC repeater, or when the repeater is controlled by the cellular phone over link 104. Necessary modifications are embodied in a link control unit that is incorporated into the cellular telephone. Many of the modifications that may be necessary to enable the user's cellular telephone to participate on the link 104 are available in devices that are Bluetooth compliant. Specific modifications for use of a telephone with a UDC repeater include a mechanism according to which the normal transmit and receive RF signals 109 (FIG. 1) are translated to different frequencies, as dictated by the applicable frequency offset encountered in up/down conversion. RWM and Shared Identity repeaters invoke in the cellular telephone the capacity to disable the cellular telephone RF section and to transfer baseband signals through the cellular telephone's control unit for link 104. In applications in which the phone itself serves as the owner interface, the cellular telephone requires additional software to deliver the applicably revised cellular telephone user interface.

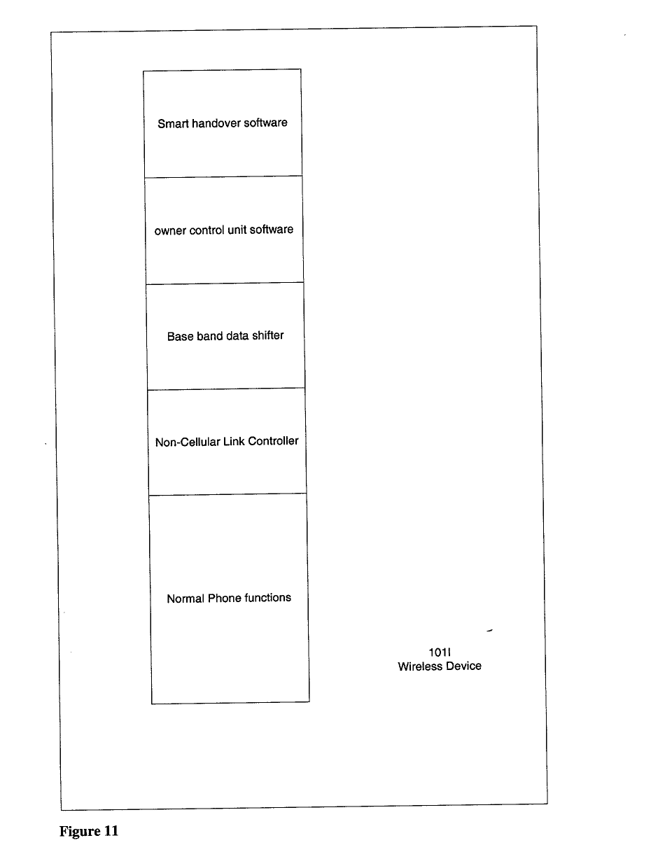

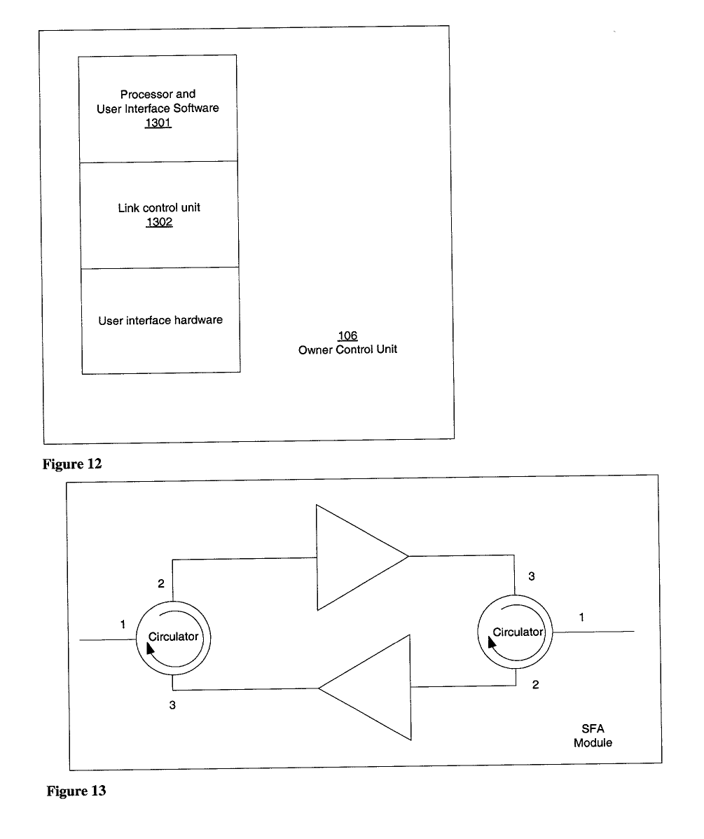

A graphical depiction of anticipated modifications to a wireless device 101I is illustrated in FIG. 11 for one embodiment. A high-level graphical representation of the owner control unit is illustrated in FIG. 12. As seen therefrom, owner control unit 106 includes a front end, in the form of a processor 1301, that is programmed with user interface software. For example, a Zucotto Xpresso processor running Zucotto Slice and Sun KVM (see http://www.kvniworld.com/Articles/Zucotto.html) and Zucotto Bluetooth Stack and WAP application.

The owner control unit also includes user interface hardware 1303, such as a keyboard, and a display that may be, for example, alphanumeric. The owner control unit also includes a link control unit 1302, which may be a Bluetooth module available from Cambridge Silicon Radio (see http://www. semibiznews.com/story/OEG20000225SO004). The user interface, including hardware 1303 and software 1301, transmits owner controlled keypad activations, or textual entries, as data to the link control unit 1302. Link control unit 1302 passes that data to the repeater control unit 203 for parsing and interpretation. The user-initiated data can both program and operate the repeater 103. In addition, link control unit 1302 conveys data directed to the owner control unit from link nodes to be displayed.

In some embodiments, owner control unit 106 may be integrated into a larger structure, such as an automotive back plane or into wireless device 101I. In such embodiments, the owner control unit may take advantage of existing user interface hardware, link controllers and processor.

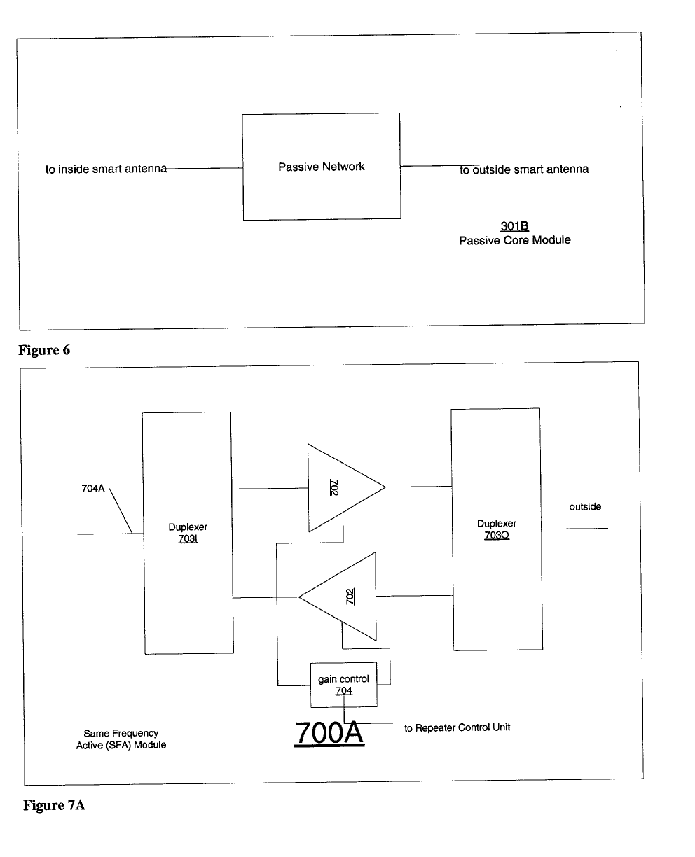

As illustrated in FIG. 6, the repeater core 202 for the Passive repeater type includes of one or more passive networks 601 between the adaptive antenna systems 201a and 201b. The passive network can be a single transmission line, in the form of, for example, twisted pair or coaxial wire. In addition, the passive network may have minimal or no length.

If multiband operation is achieved through the use of multiple antennas with different bandwidths, an embodiment of the invention may include multiple passive core modules connecting inside and outside antenna pairs for each bandwidth.

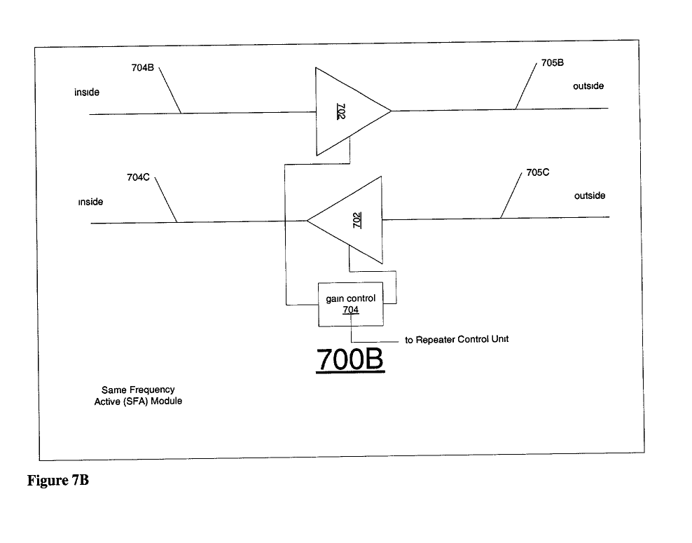

The repeater core 202 for SFA repeaters consists of one or more SFA broadband modules 700A or 700B, depicted in FIGS. 7A and 7B. The modules 700A and 700B comprise an amplifier 702A for inside to outside transmission and an amplifier 702B for outside to inside transmission.

In an SFA module, the output signal at the antenna is an amplified version of the input to the SFA repeater. If there is a feedback path from the output to the input, oscillation or other instabilities may occur. Such feedback may arise from numerous mechanisms. For example, in all SFA applications, there exists an opportunity for feedback between the outside and inside antennas. In addition, feedback may be propagated through duplexers (see FIG. 7A), or may propagate among the inside antennas and among the outside antennas (see FIG. 7B). Nevertheless, such feedback may be mitigated by duplexer isolation properties or by antenna isolation properties. Duplexing filters are particularly effective when the forward (outside-to-inside) and reverse (inside-to-outside) transmission occur on non-overlapping frequency bands. This situation obtains in the application of most conventional cellular technologies, such as AMPS, GSM, IS-136 and IS-95.

Isolation may be achieved in different ways. One way is to use two different antennas for each transmit path 700A isolating antenna Rxᵢₙ from Txᵢₙ and antenna Rxₒᵤₜ from Txₒᵤₜ as illustrated in FIG. 7B. In addition, broadband isolation can be achieved by polarization, spatial, and/or pattern separation. If multiband operation is not desired, the antennas and amplifiers may be narrowband, since most cellular protocols transmit and receive on different frequencies.

Rather than providing isolated separated transmit and receive antennas, duplexers 703I and 703O may be used in some embodiments to provide isolation between send and receive as illustrated in FIG. 7A. This arrangement enables combined transmit receive antennas on the inside and the outside. Duplexers are a well understood art and available from many manufacturers, such as Murata and Signal Technology Corporation.

Circulators are one form of duplexer that can be used. Circulators have low insertion loss and can be made to work over wide bandwidths. A typical circulator configuration is illustrated in FIG. 13.

Again, because most cellular protocols specify transmission and reception on disparate frequencies, isolation can then be achieved using narrowband duplexing filters rather than circulators. Duplexing filters are generally much lower in cost, but have higher insertion loss. Using narrowband filters makes the module protocol specific. Therefore, modules would be required for each band and protocol supported.

Optional gain control 704 of the amplifiers 702A and 702B is provided in those applications that so require. The gain control 704 takes signals from the repeater control unit 203 and adjusts the gain accordingly. In embodiments with gain control, the control signals can be analog or digital signals applied to a control pin on the amplifier.

One disadvantage of broadband module 700A and 700B is that once repeater 103 (FIG. 1) is enabled, other users may access the repeater. An SFA embodiment that can provide qualified handover uses one or more UDC modules 800. The wireless phone 101 would need to inform the repeater control unit 203 of the cellular channel on which the phone operates. In this case, the inside input and outside output frequencies are identical, as are the inside input and outside output frequencies in the UDC module 800, and are set to the cellular channel. Only the phone transmitting on the proper channel would be mixed to the proper intermediate frequency. If the repeater disallowed repeater operation for a user, module 800 would not be enabled.

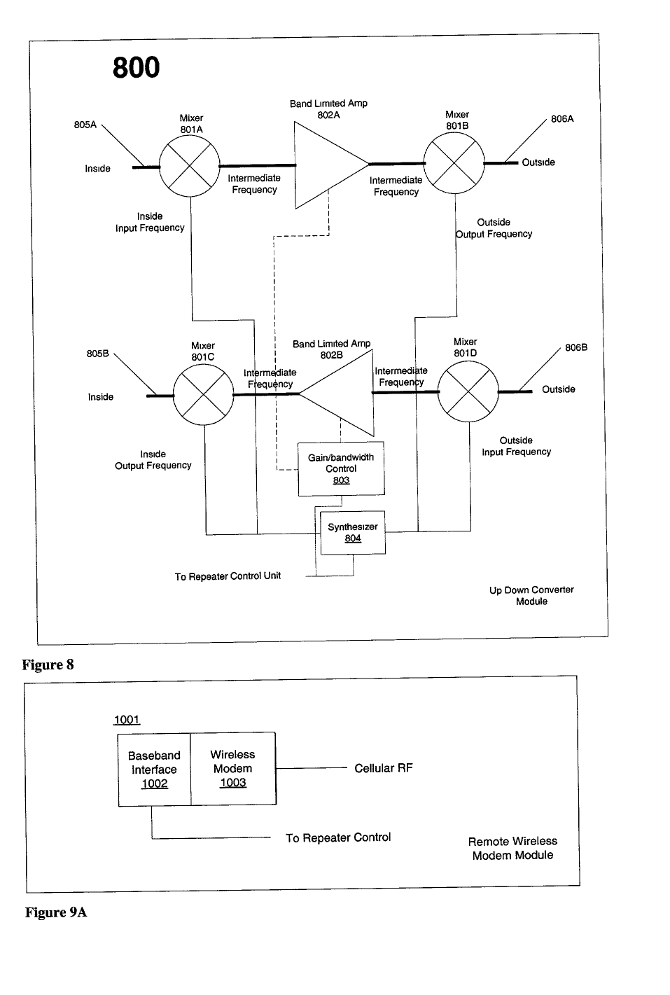

As may be seen in FIG. 8, one embodiment of repeater core 202 for UDC repeaters consists of one or more UDC modules 800. Modules 800 include a frequency synthesizer 804, a mixer 801 and band-limited amplifier 802 for the inside to outside path, as well as a mixer 801 and band-limited amplifier 802 for the outside to inside path. In some embodiments a gain and/or bandwidth control 803 is required. In such embodiments, the control signals may be analog or digital signals applied to a control pin on the amplifier 803.

Operation of UDC module 800 usually implies that the phone operates on a frequency different from standard cellular frequencies. Accordingly, UDC operation requires that the phone's own internal synthesizer be programmed to operate on these frequencies. Operation on different frequencies typically necessitates concomitant retrofitting of frequency-selective devices. In some cases, an additional transceiver may be required.

In the UDC phone/repeater system, the phone routes its baseband data either through its normal cellular channel (Co), via its internal up/down frequency converter and antenna, or through an alternate channel (C1), via the same, or possibly alternative, UDC module and/or antenna.

There exist two solutions to the provision of an alternate channel. According to one, the alternate channel, C1, may be offset from the true channel, C0, by a fixed frequency. In this instance, C1=C0+F₀, where F₀ is the fixed frequency offset. It is contemplated that F₀ may or may not be the same for every call or for every user. Alternatively, the frequency offset may be variable. In this instance, F₀ is determined by the repeater and is communicated over link 104.

The fixed offset solution makes the added phone 101 hardware and software relatively straightforward. However, other phones 101 that know this offset may access the repeater once the repeater is enabled. This possibility may be deemed undesirable in some embodiments, as when access to the repeater is to be limited, for example, as described in reference to qualified handover. The fixed-offset approach renders multi-user operation transparent to the repeater. The narrowband amplifier 802 is designed with bandwidth sufficient to accommodate the appropriate cellular bandwidth of operation.

The specified channel approach allows repeater usage only when permitted by the programming in the repeater control unit 203. The phone 101 must receive information from repeater indicating the frequency C1 on which to transmit. However, this approach may require a more complicated internal synthesizer design for cellular phone 101. In addition, the specified channel solution must have an UDC module 800 in the repeater for every user to be accommodated. The UDC module may be designed to handle bandwidths for different protocols if the amplifier bandwidth 802 is made programmable. Bandwidth is controlled through the repeater control unit 203.

A drawback associated with UDC is that any signal in the UDC frequency band may be broadcast inadvertently. For example, if link 104 uses the Bluetooth protocol and the UDC repeater uses frequencies in 2.4 GHz ISM band, then link 104 transmissions may be inadvertently radiated by the repeater.

If the intermediate frequency is identical to an outside or inside frequency, one or more of the mixers may be removed.

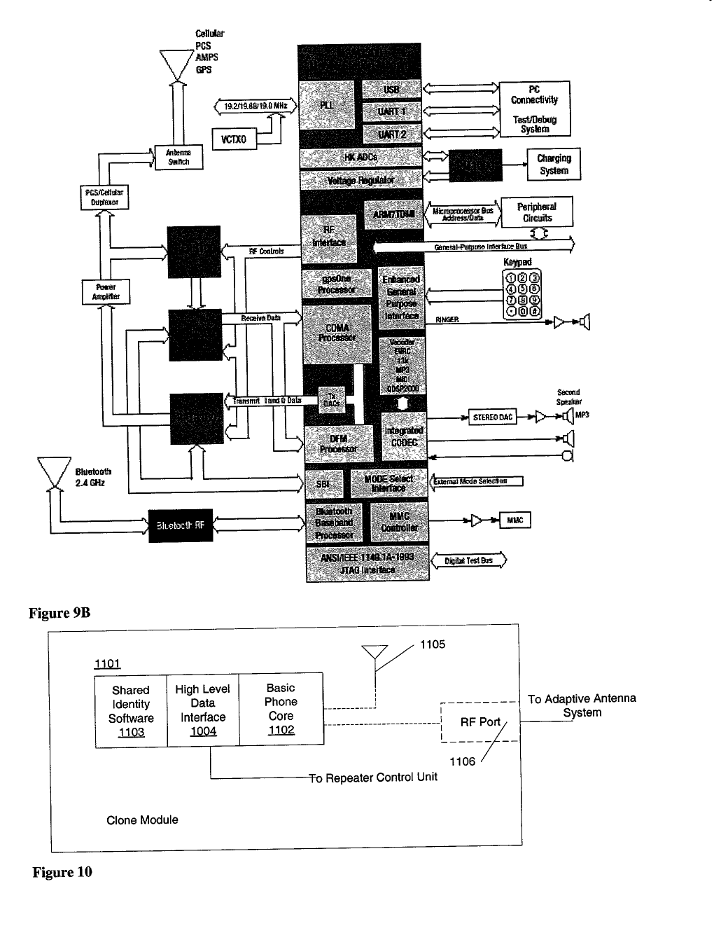

The repeater core 202 for a RWM repeater includes one or more wireless modem modules 1001, as depicted in FIG. 9A. RWM modules 1001 comprise a baseband interface 1002 and a wireless modem 1003. Wireless modems are well known and many models are available from manufacturers. For example, a mobile station modem (MSM) chipset (including e.g. MSM3300) is available from Qualcomm Incorporated, San Diego, Calif., and a model AD20 mps 430 chipset is available from Analog Devices, Norwood, Mass. A block diagram of the model MSM3300 chipset is provided in FIG. 9B.

Baseband data is exchanged between the repeater control unit 203 and the wireless modem 1003 through a baseband interface 1002 that includes electronic hardware. In some embodiments, the wireless modem contains a link controller, as does the Qualcomm MSM3300, for example. This feature of the RWM may obviate the need for the repeater control unit 203 in some embodiments.

Modems 1003 are, in general, protocol specific. However, the modems are in many instances able to accommodate more than one protocol or frequency band. Modem 1003 may exist as a single integrated circuit, or may be a discrete implementation constructed from parts, such as synthesizers, mixers, amplifiers, and, possibly, a baseband processor ASIC. Furthermore, in some instances, modem 1003 may be realized as a software radio, enabling protocols to be dynamically changed and downloaded.

The RWM repeaters do not require the inside adaptive antenna system 201 because information is sent as baseband data via the control link 104.

The advantage of RWM repeaters is the avoidance of the requirement to duplicate the full features of a phone, as is mandatory with the Shared Identity repeater. Furthermore, the phone 101 retains its unique identity, thereby avoiding potential regulatory constraints or anomalous operation at the base station.

A disadvantage of the RWM is that a significant amount of software development may be required for modem 1003 to function as required in this mode. Also, RWM operation requires the cellular phone 101 to assume the added responsibility of controlling the baseband functionality of modem 1003. For example, RF gain control and channel selection changes may need to be transmitted over the control link 104. Furthermore, additional modules may be needed for each user or new protocol.

Cellular protocols such as CDMA can be characterized high baseband data rates. IS-95 is 1.23 Mbps, and third-generation systems may have 4 Mbps baseband rates. This may impose a burden on supporting control over the data link 104. Alternatively, more processing may be allocated to the RWM module 1001. Type approval is also required in some embodiments. Since phone cores 1102 already exist, it may be easier to use these cores directly in a Shared Identity repeater embodiment.

The repeater core 202 for Shared Identity repeaters includes one or more Shared Identity phone modules 1101 (FIG. 10). Modules 1101 includes a basic phone core 1102 and modified software 1103, as well as a high-level data interface 1104.

The basic phone core 1102 is a complete working phone module. It may have the capability to operate on several frequency bands and protocols. Such phone cores are well known in the art and are available from many manufacturers. In some cases, the phone core 1102 contains a link controller that may eliminate the need for the repeater control unit 203 in some embodiments.

Shared Identity phone modules 1101 do not have hard-wired electronic serial numbers (ESNs). The ESNs distinguish between different cellular phones and are currently required by the FCC. The modified software must take identity information (such as ESN and SSD) and operating information (such as frequency band, protocol, channel) passed over the link 104 through the repeater control unit 203 and emulate the identity of the associated user phone 101.

Clone repeaters do not require an inside adaptive antenna system, inasmuch as all data is sent as baseband over the control link 104. Note that a clone module 1101 may have its own antenna 1105, as in a T28 GSM phone, or may have an RF port 1106 for connection to an adaptive antenna system, as described herein. Such a clone module 1101 may include a repeater control unit, as does the T28 GSM phone. The advantage of such a clone module is that cellular phones are already produced in quantity and therefore lower in cost when compared to a RWM alone. A disadvantage is that additional modules may be needed for each user or new protocol. Another disadvantage is that, depending on the implementation, governmental regulations may limit Shared Identity operation.

In one embodiment, repeater 103 is programmed to respond only to telephones 101 in a preferred group. The preferred group may include only phones having a desired set of property values. Relevant phone properties include the phone manufacturer, operating protocol and owner. Use of the preferred groups may be appropriate, for example, in avoiding unauthorized use of resources, incompatibility between certain phones, and/or the provision of phone-brand enhancement. Programming is done by the owner or manufacturer through the owner interface 106 and/or the phone 101. Security is effected so that only the owner/manufacturer is afforded the ability to modify repeater programming. The programmed information is stored in memory 502 in the repeater control unit 203.

The repeater 103 is activated through a request on link 104. The user can place the request through the owner interface 106 and/or the phone 101. In some embodiments, the protocol of link 104 provides automatic discovery of compatible devices, such as Bluetooth. Under these conditions, the phone 101 may request access to the repeater 103 using a smart handover. After the request for access is made, the repeater 103 queries the phone 101 for the phone's property values. Acceptable values are pre-programmed into the repeater prior to usage. If the phone has acceptable property values and the repeater has the capacity and operating characteristics to handle the phone, the phone is allowed access.

Note that in the case of Passive repeaters and broadband SFA repeaters, once the repeater is turned ON for a phone, it may be used by other phones, regardless whether the other phones are in a preferred group. Note that phones 101 do not require communications over link 104 to access the repeater once the repeater is turned ON. However, in some embodiments, link 104 may nonetheless be relied on to impart security features to these repeaters.

Rather than making access to a repeater a binary determination, the preferred group may establish a priority for handover. That is, if the repeater has a limited capacity to accommodate users, the repeater may prioritize repeater access based on phone properties. In this way, a phone that is not in the preferred group may gain access, but only if a preferred group member is not contending for access.

When an access request is made to the repeater, the phone transmits its ESN and/or other identifying information via link 104. The repeater will also require any other pertinent information, such as shared secret data, required only for use with the Shared Identity configuration, that may be used in authentication and security operation of cellular systems.

When the phone is ready to handover, it optionally disables its own RF section and commands the Shared Identity module to activate its own RF section. The phone then begins sending and receiving data directly from the Shared Identity module. A temporary transient that may arise as the RF switches should not pose a problem, inasmuch as cellular systems are robust to “drop-outs” that persist for durations on the order of a second or more. The operation described above in this paragraph is similarly applicable to RWM repeaters.

The robust nature of the functionalities afforded through an adaptive repeater system enable numerous operating options, heretofore not readily available. Examples of certain operating options are now described. Car repeater is programmed via Bluetooth, such that the protocol implemented by link 104 responds only to specified manufactured telephones. An owner may buy a cellular phone, and at the same time acquire an associated phone module for his automotive repeater, if necessary. The owner takes their phone to a car, and selects car programming from a phone menu. A PIN provided by auto manufacturer is used to access the car's Bluetooth system. The phone is now associated with automobile and may be used for further Bluetooth system programming, such as format of display for GPS navigation system.

In addition, the owner may program the repeater to only respond to her phone number and her husband's phone number. She selects an option that would require the repeater to prompt for an access code (using phone keyboard or dashboard) to prevent an undesired person with trusted device from accessing the repeater system. In this way, teenage children may be blocked from repeater use. Such a car may be deliberately designed by an automobile manufacturer to significantly affect (e.g. attenuate by 80%) the radio frequency transmissions from such phones, so that a repeater is required.

In one scenario, the user walks to the car, carrying on a conversation with hand-held phone, Bluetooth discovery is made between the phone and car. The phone determines that signal strength is adequate, and no action is taken. The phone continues to monitor signal strength. As the user enters the car, continuing her conversation, signal strength drops below threshold and the phone instructs the repeater to turn on the repeater queries the phone for the phone's properties, recognizes phone as a trusted device and turns ON. Hysteresis in the algorithm prevents unnecessary switching. As the user drives to their destination and leaves the car, for example with a briefcase, the repeater recognizes loss of Bluetooth connection and shuts down.

In another or a continuing scenario, assume that the owner's phone and laptop computer are in the briefcase and turned ON and are Bluetooth connected. Upon entry into the car, the phone makes a Bluetooth connection with repeater and turns the repeater On. The laptop computer requests email synchronization via the phone. The phone places a call via the repeater, and performs synchronization in concert with the laptop computer and a remote server. Upon exiting the car, the owner leaves the briefcase in car. Even though the automobile is turned OFF, the repeater-phone-laptop computer system continues to operate, synchronizing laptop computer.

In a further or continuing scenario, assume an owner and two passengers enter the car on business trip and that the owner's phone is in the briefcase. A first passenger attempts to use his phone in car and fails. The owner then enables his repeater to provide access for the passenger's phone using a set of dashboard located controls. Both the owner and the first passenger use their respective phones. The owner uses her phone in hands-free mode. The car has a built-in microphone and speaker that use Bluetooth to pass audio to the phone in the briefcase. The repeater handles both the owner and the passenger calls simultaneously. Another passenger who tries to use their phone fails, even after repeater access is given. The owner informs the passenger that the system works only for phones of certain manufacturers.

Certain features described herein may be applicable in common to a number of the repeater types described above. For RWM and Shared Identity repeater types, the inherent phone gain control is sufficient for operation. For other repeater types, gain control may be necessary in situations where the user phone to the repeater and the dynamic range of the phone cannot accommodate the increased gain added by the repeater. This occurs, for example, when a vehicle is very close to a cell site, and the repeater gain is unnecessary.

In one embodiment, a gain control simultaneously changes the gain of the repeater in both directions by the same amount. The effect is to maintain changes in RF signal levels similar to those experienced as a result of true path loss.

For SFA and UDC repeaters that are broadband, more than one user may access the repeater. This can also cause unwanted distortion products. Simultaneous gain control in both directions operates to reduce these effects.

Although, gain control itself is well understood in the art, an embodiment described herein relates to the use of gain control in a repeater, applied to both directions in the same degree simultaneously.

The criteria for turning the repeater ON and OFF may be controlled autonomously by the phones themselves. This is called “smart handover”. This is, in effect, an adaptive antenna system in which the antenna array consists of the repeater (treated as one antenna) and the phone cellular antenna. The phone adapts the antenna array based on some signal information that it processes.

For example, the phone can monitor its received signal strength whenever a link 104 is formed with the repeater. If the received signal strength is adequate, the repeater will not be used. If the received signal strength drops below a threshold, the phone can request to enable the repeater (soft handover), and, if the repeater type allows, (UDC, RWM, Shared Identity), switch off the phone cellular antenna (hard handover). Soft handover refers to the process of switching the repeater ON or OFF without changing the phone's main cellular RF radiation. Hard handover refers to switching the repeater ON and turning OFF the phone's primary section, cellular RF or vice versa.

This adaptive antenna system avoids cutting off the phone while standing near a car, building or other structure to prevent obtaining a connection that is worse than in the absence of the repeater. In the case of passive and SFA repeaters, once the repeater is enabled, it may affect other users in the proximity. In most cases, however, the inside coverage of the repeater will be poor outside of the structure, reducing the likelihood of problems.

One exemplary repeater 103 operates over more than one frequency band. For example it may be designed to cover both cellular (824-894 MHz) and PCS (1850-1990 MHz). Multiband operation is achieved by using antennas designed for multi-band operation or multiple antennas operating on different bands.

When using multiband antennas, SFA and UDC repeaters also require isolation between transmit and receive sections, in order to avoid oscillation. Isolation is achieved using wideband circulators or narrowband duplexing filters. The use of narrow band duplexers prevents multi-protocol operation, in some cases, because the duplexer is band-specific. For example, a duplexer designed for GSM operation will not work for AMPS operation. Multi-protocol operation in these cases would be achieved by providing more than one module. When using multiple antennas operating on different bands to perform transmit/receive isolation, the transmit and receive antennas must be isolated from each other.

The RWM and Shared Identity repeaters are essentially phone modules with specific protocols built in. Multiband operation is achieved in this instance by relying on the phone module's inherent multiple-band operation, or by using multiple modules.

Passive and SFA repeaters do not discriminate between users and are, therefore, inherently multi-user, other than when SFA is implemented with UDC module.

Fixed frequency offset UDC repeaters are also multi-user, insofar as all users use the same up/down frequency split.

UDC repeaters may be constructed of multiple modules, each module handling a different frequency for each phone user. RWM and Shared Identity repeaters require a module for each user and each protocol. In all these cases, the number of modules limits capacity of the repeater to the number of modules installed.

For data transmission, it is not necessary to have access to the repeater at all times. Therefore the repeater may timeshare access using some predetermined algorithm (for example, round-robin) based on a programming in its control unit. In this mode, the phones must announce, at access time via link 104, that they are using the repeater for data access and not voice. Voice access takes priority in one embodiment so as to avoid dropouts in the call.

In one embodiment, a manufacturer programs the core modules with a personal identification number (PIN) using the Bluetooth connection, and thereby binds the owner control unit to the modules. Thereafter, the user programs the modules with allowed phone numbers via the owner control unit. According to the programming process, a WAP application in the owner control unit receives a PIN from the user. The PIN is then transmitted via a Bluetooth stack to implicated repeater modules. One or more of the repeater modules receives the PIN, and sends an acknowledgement message to the owner control unit via Bluetooth. At the owner control unit, the WAP displays a request for allowed phone numbers and receives numbers entered by the user. The entered numbers are sent via Bluetooth to the repeater modules that accepted the PIN, and those modules store the numbers in nonvolatile memory.

In one application of the just-described embodiment, a user's cellular phone (which acts as device 101I) is powered ON, but is not connected to the cellular system. The phone's internal software requests a voice mail (or e-mail) update. The phone examines receive signal strength (rssi) and determines that service is poor because, for example, the received signal level is less that or equal to −120 dBm. The phone then scans the Bluetooth link for repeater service, and finds two unused repeater modules, herein referred to as Module 1 and Module 2.

Next, the phone requests via the Bluetooth link, access on Module 1. Hypothetically, Module 1 may have been selected as the least recently used module among the unused modules. Also, the phone sends its identity data, including phone number, ESN and, optionally, shared secret data. For example, the phone's WAP application generates a command for Bluetooth access, wherein the command contains the phone's identity data. The phone's Bluetooth stack packetizes the command and sends the command over the Bluetooth link.

In response, the repeater matches the phone number against a list of allowed phone numbers, finds that the received phone number is present in the list, and sends back an access-grant message via the Bluetooth link. For example, on receipt of a command, repeater application software in each repeater module checks for the received phone number in the list of allowed phone numbers. If the phone number is found in the list, the repeater software overwrites its own identity data with the identity data received in the command, and then generates an access grant message that is packetized and sent by the Bluetooth stack. This process is referred to herein as qualified handover.

In response to the access-grant message, the phone sends to repeater Module 1, via the Bluetooth link (the cellular section of the user's phone is not used) a phone number to be dialed to obtain the voice mail. Repeater Module 1 starts using its cellular call processing circuitry (this is an example of smart handover) to dial the phone number, while using the identity data received from the user's phone as its own identity (this is an example of Shared Identity).

When the voice mail service answers, repeater Module 1 sends a connect message to the user's phone again via the Bluetooth link. Thereafter, the user's phone sends, via the Bluetooth link, the data to be sent to the voice mail service, in order to obtain the voice messages. Repeater Module 1 then sends the data from the user's phone to the voice mail service via the cellular link. The voice mail service in turn responds with the voice mail message that is received by the repeater Module 1. Repeater Module 1 in turn repeats the voice mail message over the Bluetooth link to the user phone. The user phone then transmits a “hangup” message via the Bluetooth link to the repeater Module 1. In response, repeater Module 1 hangs up on the cellular link and terminates repeater service.

While particular embodiments and implementations have been shown and described, it will be recognized to those skilled in the art that, based upon the teachings herein, further changes and modifications may be made. For example, device 101I need not be a telephone and instead can be a hand-held organizer, such as PALM PILOT™. Thus, the appended claims are to encompass within their scope all such changes and modifications.

Although specific embodiments, and examples for, the invention are described herein for illustrative purposes, various equivalent modifications can be made without departing from the spirit and scope of the invention, as will be recognized by those skilled in the relevant art. The teachings provided herein of the invention can be applied to other systems for telecommunications systems, not necessarily the cellular and Bluetooth based system generally described above. The various embodiments described above can be combined to provide further embodiments. The illustrated methods can omit some acts, can add other acts, and can execute the acts in a different other than that illustrated to achieve the advantages of the invention. The teachings of the applications, patents and publications referred to herein, are incorporated by reference in their entirety, including, but not limited to, U.S. patent application Ser. No. 09/,616,386, filed Jul. 14, 2000; U.S. Pat. No. 5,600,333; and Jennifer Bray and Charles Sturman, Bluetooth: Connect Without Cables, Prentice Hall (2000), which are each incorporated in their entirety.

These and other changes can be made to the invention in light of the above detailed description. In general, in the following claims, the terms used should not be construed to limit the invention to the specific embodiments disclosed in the specification, but should be construed to include all telecommunications systems that operate in accordance with the claims. Accordingly, the invention is not limited by the disclosure, but instead its scope is to be determined entirely by the following claims.

1. A communications subsystem for installation with respect to a structure, comprising:
a repeater;
an external antenna system coupled to the repeater and including at least a portion of at least a first antenna positioned outside of the structure to provide cellular communications with a base station;
an internal antenna system coupled to the repeater and including at least a portion of at least a second antenna positioned inside of the structure to provide cellular communications with an end user communications device; and
a controller controllingly coupled to the repeater by a non-cellular communications link.

2. The communications subsystem of claim 1 wherein the controller comprises logic in the end user communications device to autonomously control the repeater.

3. The communications subsystem of claim 1 wherein the repeater is an Up/Down Converter repeater.

4. The communications subsystem of claim 1 wherein the repeater comprises:
a repeater core;
a first repeater module to provide a first set of operating characteristics for the repeater including a first communications protocol, a first communications frequency band, and a first operating protocol;
a second repeater module to provide a second set of operating characteristics for the repeater, the second set of operating characteristics including a second communications protocol different than the first communications protocol of the first set of operating characteristics; and
a switch selectively coupling the first repeater module and the second repeater module to the repeater core.

5. The communications subsystem of claim 1, further comprising:
a first repeater module removably couplable to the repeater to provide a first set of operating characteristics for the repeater including a first communications protocol, a first communications frequency band, and a first operating protocol; and
a second repeater module removably couplable to the repeater in place of the first repeater module to provide a second set of operating characteristics for the repeater, the second set of operating characteristics including a second communications protocol different than the first communications protocol of the first set of operating characteristics.

6. The communications subsystem of claim 1 wherein at least one of the internal and the external antenna systems is an adaptive antenna system.

7. The communications subsystem of claim 1, further comprising:
the end user communications device wherein the end user communications device is a cellular telephone.

8. The communications subsystem of claim 1 wherein the structure takes the form of a vehicle.

9. The communications subsystem of claim 1 wherein the structure takes the form of a building.

10. A communications subsystem for installation with respect to a structure, comprising:
a repeater;
an external antenna system coupled to the repeater and including at least a portion of at least a first antenna positioned outside of the structure to provide cellular communications with a base station;
an internal communications link coupled to the repeater to provide non-cellular communications with an end user communications device; and
a controller controllingly coupled to the repeater by a non-cellular communications link.

11. The communications subsystem of claim 10 wherein the repeater is a remote wireless modem.

12. The communications subsystem of claim 10 wherein the repeater is a cellular communications device, the cellular communications device having a set of identity data that mimics a set of identity data identifying the end user communications device.

13. A communications subsystem for installation with respect to a structure, comprising:
an external antenna system including at least a portion of at least a first external antenna positioned outside of the structure to provide at least one of forward and reverse cellular communications with a base station;
an internal antenna system including at least a portion of at least a first internal antenna positioned inside of the structure and to provide at least one of forward and reverse cellular communications with an end user communications device; and
an Up/Down converter repeater coupled to the external antenna system and the internal antenna system to communicate with the base station at a first frequency and to communicate with the end user communications device at a second frequency, different from the first frequency.

14. The communications subsystem of claim 13, further comprising:
a controller controllingly coupled to the repeater by a non-cellular communications link.

15. A communications subsystem for installation with respect to a structure, comprising:
an external antenna system including at least a portion of at least a first external antenna positioned outside of the structure to provide at least one of forward and reverse cellular communications with a base station; and
an internal communications link having at least a portion of the internal communications link inside the structure to provide at least one of forward and reverse non-cellular communications with an end user communications device; and
a remote wireless modem repeater coupled to the external antenna system and the internal communications link to convert between cellular communications and non-cellular communications.

16. The communications subsystem of claim 15, further comprising:
the end user communications device wherein the end user communications device has an RF cellular transmitter temporarily rendered inoperative.

17. The communications subsystem of claim 15, further comprising:
the communications device wherein the end user communications device includes a digital signal processor programmed to function as a software radio.

18. A communications subsystem for installation with respect to a structure, comprising:
an external antenna system including at least a portion of at least a first external antenna positioned outside of the structure to provide at least one of forward and reverse cellular communications with a base station; and
an internal communications link having at least a portion of the internal communications link inside the structure to provide at least one of forward and reverse non-cellular communications with an end user communications device; and
a cellular communications device coupled to the external antenna system and the internal communications link to convert between cellular communications and non-cellular communications, the cellular communications device having a set of identity data that mimics a set of identity data identifying the end user communications device.

19. The communications subsystem of claim 18, further comprising:
the end user communications device wherein the end user communications device has an RF cellular transmitter temporarily rendered inoperative.

20. A communications subsystem for installation with respect to a structure, comprising:
a repeater; and
a first repeater module removably couplable to the repeater to provide a first set of operating characteristics for the repeater comprising at least one of a first communications protocol, a first communications frequency band, and a first operating protocol.

21. The communications subsystem of claim 20, further comprising:
a second repeater module removably couplable to the repeater in place of the first repeater module to provide a second set of operating characteristics for the repeater, the second set of operating characteristics including a second communications protocol different than the first communications protocol of the first set of operating characteristics.

22. The communications subsystem of claim 20, further comprising:
a second repeater module removably couplable to the repeater in place of the first repeater module to provide a second set of operating characteristics for the repeater, the second set of operating characteristics including a second communications frequency band different than the first communications frequency band of the first set of operating characteristics.

23. The communications subsystem of claim 20, further comprising:
a second repeater module removably couplable to the repeater in place of the first repeater module to provide a second set of operating characteristics for the repeater, the second set of operating characteristics including a second operating protocol different than the first operating protocol of the first set of operating characteristics.

24. The communications subsystem of claim 20, further comprising:
a second repeater module removably couplable to the repeater concurrently with the first repeater module to provide a second set of operating characteristics for the repeater, the second set of operating characteristics including a second communications protocol different than the first communications protocol of the first set of operating characteristics.

25. The communications subsystem of claim 20, further comprising:
a second repeater module removably couplable to the repeater concurrently with the first repeater module to provide a second set of operating characteristics for the repeater, the second set of operating characteristics including a second communications frequency band different than the first communications frequency band of the first set of operating characteristics.

26. The communications subsystem of claim 20, further comprising:
a second repeater module removably couplable to the repeater concurrently with the first repeater module to provide a second set of operating characteristics for the repeater; and
a switch between the repeater and the first and the second repeater modules, the switch selectively operable to alternatively couple one of the first and the second repeater modules to the repeater.

27. The communications subsystem of claim 20 wherein the first repeater module is a remote wireless modem repeater module, comprising:
an RF transceiver coupled to a first communications link to transmit and receive cellular communications; and
a baseband interface between the RF transceiver and a second communications link to transmit and receive non-cellular baseband communications.

28. The communications subsystem of claim 20 wherein the first repeater module is a shared identity repeater module, comprising:
a phone core couplable to a first communications link to receive and transmit cellular communications;
a high level data interface between the phone core and a second communications links to receive and transmit non-cellular baseband communications, including identity information for an end-user communications device; and
computer-readable instructions to mimic the identity information for the end-user communications device.

29. The communications subsystem of claim 20, further comprising:
a wireless communications link including an external antenna system; and
a wired communications link, wherein the repeater is coupled between the wireless and the wired communications links to transfer communications signals between a base station located externally with respect to a structure and an end user communications device located internally with respect to the structure.

30. The communications subsystem of claim 20, further comprising:
a cellular wireless communications link including an external antenna system; and
a non-cellular wireless communications link including an internal antenna system, wherein the repeater is coupled between the cellular and the non-cellular communications links to transfer communications signals between a base station located externally with respect to a structure and an end user communications device located internally with respect to the structure.

31. A communications subsystem for installation with respect to a structure, comprising:
a first communications link;
a second communications link; and
a repeater coupled to the first and the second communications links to transfer communications signals therebetween, the repeater comprising:
a first repeater module to provide a first set of operating characteristics for the repeater, the first set of operating characteristics comprising at least one of a first operating protocol, a first communications protocol, and a first communications frequency band; and
a second repeater module to provide a second set operating characteristics for the repeater, the second set of operating characteristics comprising at least one of a second operating protocol, a second communications protocol, and a second communications frequency band.

32. The communications subsystem of claim 31, further comprising:
a switch selectively controlled by an end user cellular communications device to alternatively active one of the first and the second repeater modules to the repeater.

33. The communications subsystem of claim 31, further comprising:
an owner control unit; and
a switch selectively controlled by the owner control unit to alternatively activate one of the first and the second repeater modules to the repeater.

34. The communications subsystem of claim 31 wherein the second set of operating characteristics matches the first set of operating characteristics.

35. The communications subsystem of claim 31 wherein the second set of operating characteristics is different than the first set of operating characteristics.

36. The communications subsystem of claim 31 wherein the second communications link is wired.

37. A method of operating a communications subsystem, comprising:
receiving a forward cellular communications signal from a base station at an external antenna of an external antenna system;
receiving repeater control signals by way of a non-cellular communications link;
controlling the configuration of a repeater in response to the received control signals; and
repeating the forward communications signal at an internal antenna of an internal antenna system based at least in part on the configuration of the repeater.

38. A method of operating a communications subsystem, comprising:
monitoring a cellular communications signal received at an end user communications device; and
producing a non-cellular request from the end user communications device to modify at least one operating parameter of a repeater based on the monitored cellular communications signal.

39. The method of claim 38 wherein producing a non-cellular request from the end user communications device to modify at least one operating parameter of a repeater based on the monitored cellular communications signal comprises producing a non-cellular request signal identifying an ON/OFF state for the repeater.

40. The method of claim 38, further comprising:
detecting the presence of the repeater within a proximity of the end user communications device, and where producing a non-cellular request from the end user communications device to modify at least one operating parameter of a repeater based on the monitored cellular communications signal comprises producing a non-cellular request signal identifying an ON/OFF state for the repeater.

41. The method of claim 38 wherein producing a non-cellular request from the end user communications device to modify at least one operating parameter of a repeater based on the monitored cellular communications signal, comprises:
producing a non-cellular request signal for placing at least a portion of the repeater in the ON state if a strength of the monitored cellular communications signal is below a predefined reference signal strength; and
producing a non-cellular request signal for placing at least a portion of the repeater in the OFF state if the strength of the monitored cellular communications signal is above the predefined reference signal strength.

42. The method of claim 38 wherein producing a non-cellular request from the end user communications device to modify at least one operating parameter of a repeater based on the monitored cellular communications link, comprises:
producing a non-cellular request signal for placing at least a portion of the repeater in the ON state if a quality of the monitored cellular communications link is below a predefined reference signal quality; and
producing a non-cellular request signal for placing at least a portion of the repeater in the OFF state if the quality of the monitored cellular communications link is above the predefined reference signal quality.

43. The method of claim 38 wherein producing a non-cellular request from the end user communications device to modify at least one operating parameter of a repeater based on the monitored cellular communications signal comprises producing a non-cellular request signal identifying an ON/OFF state for at least one of a number of modules of the repeater.

44. The method of claim 38 wherein producing a request from the end user communications device includes producing a request signal on a non-cellular communications link formed between repeater and the end user communications device.

45. A method of operating a communications subsystem, comprising:
receiving a non-cellular request from an end user communications device at a repeater over a non-cellular communications link;
modifying at least one operating parameter of the repeater based on the received non-cellular request;
receiving cellular communications at the repeater; and
repeating the received cellular communications by the repeater according to the modified operating parameters.

46. The method of claim 45 where modifying at least one operating parameter of a repeater based on the received non-cellular request includes changing an ON/OFF state of the repeater.

47. The method of claim 45, further comprising:
placing at least a portion the repeater in the ON state if a strength of a cellular communications signal received at the end user communications device at is below a predefined reference signal strength; and
placing at least a portion of the repeater in the OFF state if the strength of the cellular communications signal received at the end user communications device is above the predefined reference signal strength.

48. The method of claim 45, further comprising:
placing at least a portion the repeater in the ON state if a quality of a cellular communications link received at the end user communications device at is below a predefined reference signal quality; and
placing at least a portion of the repeater in the OFF state if the quality of the cellular communications link received at the end user communications device is above the predefined reference signal quality.

49. The method of claim 45 where modifying at least one operating parameter of a repeater based on the received non-cellular request includes changing an ON/OFF state of at least one of a number of modules of the repeater.

50. The method of claim 45 where modifying at least one operating parameter of a repeater based on the received non-cellular request includes changing an ON/OFF state of at least one of a number of modules of the repeater if the end user communications device is within a proximity of the repeater.

51. The method of claim 45 wherein modifying at least one operating parameter of the repeater based on the received non-cellular request includes modifying at least one of a first operating protocol, a first communication protocol, and a first communications frequency band.

52. A method of operating a communications subsystem, comprising:
receiving at least one piece of identifying data from an end user communications device; and
basing access to at least a portion of a repeater on the received identifying data.

53. The method of claim 52, further comprising:
querying the end user communications device for the identifying data.

54. The method of claim 52 wherein receiving at least one piece of identifying data from an end user communications device includes receiving a non-cellular communications signal carrying the identifying data.

55. The method of claim 52 wherein receiving at least one piece of identifying data from an end user communications device includes receiving a communications signal carrying a communications device manufacturer identifier, and further comprising:
selecting one of a number of repeater modules based on the received communications device manufacturer identifier; and
operating the selected one of the number of repeater modules.

56. The method of claim 52 wherein receiving at least one piece of identifying data from an end user communications device includes receiving a communications signal carrying a communications protocol identifier, and further comprising:
selecting one of a number of repeater modules based on the communications protocol identifier; and
operating the selected one of the number of repeater modules.

57. The method of claim 52 wherein receiving at least one piece of identifying data from an end user communications device includes receiving a communications signal carrying a communications frequency band identifier, and further comprising:
selecting one of a number of repeater modules based on the communications frequency band identifier; and
operating the selected one of the number of repeater modules.

58. The method of claim 52 wherein receiving at least one piece of identifying data from an end user communications device includes receiving a communications signal carrying a user identifier, and further comprising:
selecting one of a number of repeater modules based on the user identifier; and
operating the selected one of the number of repeater modules.

59. The method of claim 52 wherein receiving at least one piece of identifying data from an end user communications device includes receiving a communications signal carrying a communications device identifier, and further comprising:
selecting one of a number of repeater modules based on the communications device identifier; and
operating the selected one of the number of repeater modules.

60. The method of claim 52 wherein basing access to at least a portion of a repeater based on the received identifying data includes operating one of a number of repeater modules based on the received identifying data.

61. The method of claim 52 wherein receiving at least one piece of identifying data from an end user communications device includes rendering at least one of the number of repeater modules temporarily inactive based on the received identifying data.

62. A method of operating a communications subsystem, comprising:
at a first time,
transmitting cellular communications from an end user communications device at a first power level to provide cellular communications between the end user communications device and a base station; and
at a second time,
transmitting cellular communications from the end user communications device at a second power level, lower than the first power level, to provide cellular communications between the end user communications device and a repeater; and
operating the repeater to provide cellular communications between the repeater and the base station.

63. The method of claim 62, further comprising:
receiving a non-cellular control signal from a user control over a non-cellular communications link;
setting an ON/OFF state of at least a portion of the repeater in response to the receipt of the non-cellular control signal; and
adjusting the power level of the cellular communications transmission from the end user communications device between the first power level and the second power level in conjunction with the ON/OFF state of the at least a portion of the repeater.

64. The method of claim 62, further comprising:
receiving a non-cellular control signal from a user control over a non-cellular communications link;
activating at least a portion of the repeater in response to the receipt of the non-cellular control signal; and
reducing the power level of the cellular communications transmission from the end user communications device from the first power level to the second power level in conjunction with the activation of the at least a portion the repeater.

65. The method of claim 62, further comprising:
receiving a non-cellular control signal from a user control over a non-cellular communications link;
deactivating the repeater in response to the receipt of the non-cellular control signal; and
increasing the power level of the cellular communications transmission from the end user communications device from the second power level to the first power level in conjunction with the deactivation of the at least a portion of the repeater.

66. The method of claim 62, further comprising:
determining whether a strength of a cellular communications signal is below a threshold strength;
transmitting a non-cellular control signal to a repeater based on the determined strength of the cellular communications signal;
setting an ON/OFF state of at least a portion of the repeater based on the non-cellular control signal; and
adjusting the power level of the cellular communications transmission from the end user communications device in conjunction with the ON/OFF state of the at least a portion of the repeater.

67. The method of claim 62, further comprising:
determining whether a strength of a cellular communications signal is below a threshold strength;
transmitting a non-cellular control signal to a repeater if the strength of the cellular communications signal is below the threshold strength;
activating at least a portion of the repeater in response to the receipt of the non-cellular control signal; and
lowering the power level of the cellular communications transmission from the end user communications device from the first power level to the second power level if the strength of the cellular communications signal is below the threshold strength.

68. The method of claim 62, further comprising:
determining whether a strength of a cellular communications signal is above a threshold strength;
transmitting a non-cellular control signal to a repeater if the strength of the cellular communications signal is above the threshold strength;
deactivating at least a portion of the repeater in response to the receipt of the non-cellular control signal; and
raising the power level of the cellular communications transmission from the end user communications device from the first power level to the second power level if the strength of the cellular communications signal is above the threshold strength.

69. A method of operating a communications subsystem, comprising:
at a first time,
operating a cellular transmitter of an end user communications device at a first power level to provide cellular communications between the end user communications device and a base station; and
at a second time,
operating the cellular transmitter of the end user communications device at a second power level, lower than the first power level, to provide cellular communications between the end user communications device and a repeater; and
operating the repeater to provide cellular communications between the repeater and the base station.

70. The method of claim 69, further comprising:
receiving a non-cellular control signal from a user control over a non-cellular communications link;
setting an ON/OFF state of at least a portion of the repeater in response to the receipt of the non-cellular control signal; and
adjusting the power level of the cellular transmitter at the end user communications device between the first power level and the second power level in conjunction with the ON/OFF state of the at least a portion of the repeater.

71. The method of claim 69, further comprising:
determining whether a strength of a cellular communications signal is below a threshold strength;
transmitting a non-cellular control signal to a repeater based on the determined strength of the cellular communications signal;
setting an ON/OFF state of at least a portion of the repeater based on the non-cellular control signal; and
adjusting the power level of the cellular transmitter at an end user communications device in conjunction with the ON/OFF state of the at least a portion of the repeater.

72. A method of operating a communications subsystem, comprising:
at a first time,
transmitting cellular communications from an end user communications device to provide cellular communications between the end user communications device and a base station; and
at a second time,
transmitting non-cellular communications from the end user communications device to provide cellular communications between the end user communications device and a repeater; and
transmitting cellular communications corresponding to the non-cellular communications from the repeater to provide cellular communications between the repeater and the base station.

73. The method of claim 72, further comprising:
temporarily terminating the cellular communications transmission from the end user communications device before transmitting the non-cellular communications from the end user communications device.

74. The method of claim 72, further comprising:
receiving a non-cellular control signal from a user control over a non-cellular communications link;
activating the repeater in response to the receipt of the non-cellular control signal; and
temporarily terminating the cellular communications transmission from the end user communications device before transmitting the non-cellular communications from the end user communications device.

75. The method of claim 72, further comprising:
receiving a non-cellular control signal from a user control over a non-cellular communications link;
deactivating the repeater in response to the receipt of the non-cellular control signal; and
beginning the cellular communications transmission from the end user communications device after deactivating the repeater.

76. The method of claim 72, further comprising:
determining whether a strength of a cellular communications signal is below a threshold;
transmitting a non-cellular control signal to a repeater if the strength of the cellular communications signal is below the threshold;
activating the repeater in response to the receipt of the non-cellular control signal; and
temporarily terminating the cellular communications transmission from the end user communications device if the strength of the cellular communications signal is below the threshold.
